(19) United States
(12) Patent Application Publication
(10) Pub. No.: US 2010/0206946 A1
(43) Pub. Date: Aug. 19, 2010

(54) METHOD AND DEVICE FOR ACCEPTING OBJECTS THAT ARE TO BE TRANSPORTED

(75) Inventors: Keith Ulrich, Bonn-Oberkassel (DE); Stefan Wilms, Bocholt (DE); Achim Vieth, Koln (DE)

Correspondence Address: International IP Law Group, P.O. BOX 691927, HOUSTON, TX, 77269-1927, US

(73) Assignee: Deutsche Post AG, Bonn (DE)

(21) Appl. No.: 12/518,404

(22) PCT Filed: Dec. 12, 2007
(86) PCT No.: PCT/EP07/10873

§ 371 Date: Oct. 6, 2009

(30) Foreign Application Priority Data
Dec. 15, 2006 (EP) 06026050.2

(51) Int. Cl. G06K 17/00; B42D 15/00

(52) U.S. Cl. 235/375; 283/116; 235/487

(57) ABSTRACT

There is provided a method for accepting an object that is to be transported, for purposes of being processed in a logistics system. An exemplary method comprises acquiring graphic information via optical image recognition. The exemplary method also comprises evaluating the graphic information to ascertain mailing data about the object, and transmitting and/or storing the mailing data.

### CROSS REFERENCE TO RELATED APPLICATIONS

Pursuant to 35 U.S.C. §371, this application is the United States National Stage Application of International Patent Application No. PCT/EP2007/010873, filed on Dec. 12, 2007, the contents of which are incorporated by reference as if set forth in their entirety herein, which claims priority to European (EP) Patent Application No. 06026050.2, filed Dec. 15, 2006, the contents of which are incorporated by reference as if set forth in their entirety herein.

### BACKGROUND

It is a known procedure to provide objects that are to be transported, especially mailpieces such as letters, parcels and packages, with address labels. The address labels contain mailing information that is suitable to influence processing procedures in a logistics system.

### SUMMARY OF THE INVENTION

An exemplary embodiment of the present invention relates to a method for accepting an object that is to be transported, for purposes of being processed in a logistics system. Exemplary embodiments of the present invention may also relate to an information carrier and to a device for accepting objects that are to be transported.

An exemplary embodiment of the present invention is based on the objective of carrying out as quickly and reliably as possible the acceptance of objects that are to be transported.

According to an exemplary embodiment of the present invention, it is especially provided that a method for accepting an object that is to be transported, for purposes of being processed in a logistics system, is carried out in such a manner that graphic information is acquired and evaluated using optical image recognition, that mailing data is ascertained within the scope of the evaluation, and that the mailing data is transmitted and/or stored.

A refinement of the method, of the information carrier, of the mailpiece and of the device according to an exemplary embodiment of the present invention provides for the storage to be done on a storage medium.

A refinement of the method, of the information carrier, of the mailpiece and of the device according to an exemplary embodiment of the present invention is characterized in that the storage medium works together with a transponder.

A refinement of the method, of the information carrier, of the mailpiece and of the device according to an exemplary embodiment of the present invention provides for the storage medium to be connected to the object that is to be transported.

A refinement of the method, of the information carrier, of the mailpiece and of the device according to an exemplary embodiment of the present invention provides for the mailpieces to be dispatched into a logistics system and for at least one processing step in the logistics system to be carried out as a function of the mailing data.

A refinement of the method, of the information carrier, of the mailpiece and of the device according to an exemplary embodiment of the present invention is characterized in that the mailing data is stored and/or transmitted via an interaction with an interaction device associated with the container.

A refinement of the method, of the information carrier, of the mailpiece and of the device according to an exemplary embodiment of the present invention provides for the mailing data to be stored and/or transmitted via an interaction with a reading unit.

A refinement of the method, of the information carrier, of the mailpiece and of the device according to an exemplary embodiment of the present invention is characterized in that the interaction device contains an information memory.

A refinement of the method, of the information carrier, of the mailpiece and of the device according to an exemplary embodiment of the present invention provides that the information memory can be connected to an object that is to be mailed, that it has a surface that can be written with mailing information, and that it contains an information carrier to store acquired graphic information.

A refinement of the method, of the information carrier, of the mailpiece and of the device according to an exemplary embodiment of the present invention is characterized in that the mailing information is ascertained at least partially by an evaluation of the acquired graphic information.

A refinement of the method, of the information carrier, of the mailpiece and of the device according to an exemplary embodiment of the present invention provides for the device to comprise a reading unit to acquire graphic information that is present on a surface of an information carrier, a computing device to evaluate the graphic information, and a transmitter to transmit mailing information to a storage medium that can be connected to the information carrier.

A refinement of the method, of the information carrier, of the mailpiece and of the device according to an exemplary embodiment of the present invention is characterized in that the transmitter emits electromagnetic signals that can be received by the storage medium.

The mailing data relates especially to one or more of the following types of information: sender, invoice recipient, recipient, contact person of the sender, of the recipient or the invoice recipient, information about the contents of the mailing, information about desired additional services (for example, special delivery times) as well as mailpiece identifiers.

The invention can be executed with a plurality of devices and consequently is not restricted to individual devices.

Within the scope of an exemplary embodiment of the present invention, the term “logistics system” should be understood in a broad sense. In particular, it encompasses systems that are adapted to carry out the transportation of mailpieces from dispatch locations to delivery locations along a transportation route, preferably within a postal distribution network.

A refinement of the method, of the device, of the container and of the logistics system according to an exemplary embodiment of the present invention is characterized in that the mailing data is stored and/or transmitted by the device for accepting the objects that are to be transported.

This allows, for example, the dispatching procedure to be ascertained and, if applicable, to be transmitted—especially for tracing purposes—or to be stored—for example, for tracking purposes—when the container is dispatched.

Moreover, it is practical for the mailing data to be stored and/or transmitted via an interaction with the device.

The storage and/or transmission of the mailing data is particularly advantageous in order to achieve one or more of the following effects:
confirmation that the mailing was accepted;
transmission of the point in time when the mailpiece was dispatched from the device (for tracking the dispatched mailpieces) and/or storage of the point in time when the mailpiece was dispatched from of the device (for tracing the dispatched mailpieces).

Such types of information constitute particularly preferred examples of mailing data according to an exemplary embodiment of the present invention.

In addition to information about the fact that the dispatch has taken place, it is also possible to acquire and, if applicable, to transmit and/or store additional mailing data.

A refinement of the method, of the device, of the container and of the logistics system according to an exemplary embodiment of the present invention provides for connecting the information memory to the object that is to be transported.

A refinement of the method, of the device, of the container and of the logistics system according to an exemplary embodiment of the present invention is characterized in that the information memory contains an identifier.

A refinement of the method, of the device, of the container and of the logistics system according to an exemplary embodiment of the present invention provides for the identifier to identify the object that is to be transported.

A refinement of the method, of the device, of the container and of the logistics system according to an exemplary embodiment of the present invention is characterized in that the information memory is permanently connected to the object that is to be transported.

A refinement of the method, of the device, of the container and of the logistics system according to an exemplary embodiment of the present invention provides for information from at least one mailpiece to be acquired, whereby the information is associated with a mailpiece.

A refinement of the method, of the device, of the container and of the logistics system according to an exemplary embodiment of the present invention is characterized in that the acquired information comprises one or more codes that identify the mailpiece or mailpieces.

As a result, tracking and/or tracing of the mailpieces can be improved simply and reliably.

Logistical functions are improved according to an exemplary embodiment of the present invention. Moreover, in an especially simple and practical manner, an exemplary embodiment of the present invention provides a logistics system that allows tracking and tracing for a wide array of mailpieces.

An exemplary embodiment of the present invention makes the mailing data available directly at the dispatch location, thus accelerating the processing of the objects that are to be transported.

The delivery location is preferably selected by the party ordering the transportation. In case of a return, this is, for example, a warehouse of a vendor or manufacturer.

A refinement of the method, of the device, of the container and of the logistics system according to an exemplary embodiment of the present invention provides for a person picking up the mailpieces to complete the dispatching procedure in that he or she selects an appropriate function on an input device.

A refinement of the method, of the device, of the container and of the logistics system according to an exemplary embodiment of the present invention is characterized in that the input device is a mobile user terminal.

It is advantageous to use the dispatch data acquired according to an exemplary embodiment of the present invention in order to control logistical procedures in the logistics system.

A refinement of an exemplary embodiment of the present invention provides for at least one processing procedure to be carried out in the logistics system as a function of the mailing data.

Thus, for instance, it is possible to regulate capacities in processing centers for the mailpieces—especially in letter or parcel centers—as a function of the mailing data.

Moreover, the device can be provided with a suitable evaluation unit. This evaluation unit can be used, for example, to check whether a person picking up the mailpieces has authorization to do so. In this context, it is advantageous to provide for an identification of the person picking up the mailpieces.

For instance, the objects that are to be transported can be of different types, each of which is associated with certain method steps. In typical logistics systems, for example, in the postal sector, packages or parcels are associated with identification information such as codes, so that the route of the mailpiece in question can be regulated and tracked as efficiently as possible. Normally, such a code has to be acquired by an acquisition device on a container at the time when a mailpiece is deposited. For example, a postal number in the form of a scanned code or of a character string entered by a keypad is acquired.

During the acquisition of an identification number that identifies the mailpiece, mailpieces can also be encountered that have been additionally provided with a special Identcode that likewise has to be scanned at the time of acceptance. Moreover, these can also be COD mailpieces with COD charges that have to be entered, or else these can be any other special mailpieces that involve additional steps.

A refinement of the method, of the logistics system, of the container and of the computer program product according to an exemplary embodiment of the present invention provides for the reading unit or a data processing unit associated with it to evaluate the mailing data.

A refinement of the method, of the logistics system, of the container and of the computer program product according to an exemplary embodiment of the present invention is characterized in that the mailing data is stored.

A refinement of the method, of the logistics system, of the container and of the computer program product according to an exemplary embodiment of the present invention provides for the mailing data to be stored in the storage medium.

A refinement of the method, of the logistics system, of the container and of the computer program product according to an exemplary embodiment of the present invention is characterized in that the mailing data is stored in the reading unit and/or in the data processing unit associated with the reading unit.

An exemplary embodiment of the invention provides for the mailing data to be stored only in the reading unit and/or in the data processing unit associated with the reading unit. This has the advantage that storage space is saved in the containers, so that they are easier to manufacture.

A refinement of an exemplary embodiment of the present invention provides for the data processing unit to perform an evaluation of the mailing data.

A refinement of the method, of the logistics system, of the container, of the transportation system and of the computer program product according to an exemplary embodiment of the present invention is characterized in that at least one handling procedure of the container takes place as a function of the evaluation.

It is practical to select another transportation system, for example, if the risk exists that, if the originally intended transportation route is maintained, the mailpieces will have a longer transportation time than a specifiable target transportation time.

A refinement of the method, of the logistics system, of the container and of the computer program product according to an exemplary embodiment of the present invention is characterized in that the position of the transponder is ascertained.

A refinement of the method, of the logistics system, of the container and of the computer program product according to an exemplary embodiment of the present invention provides for the position of the container to be stored.

A refinement of the method, of the logistics system, of the container, of the transportation system and of the computer program product according to an exemplary embodiment of the present invention is characterized in that the position is stored in the data processing unit.

A refinement of the method, of the logistics system, of the container and of the computer program product according to an exemplary embodiment of the present invention provides for the position of the container to be determined and for the position of the container to be associated with the mailing data that has been received.

A refinement of the method, of the logistics system, of the container, of the transportation system and of the computer program product according to an exemplary embodiment of the present invention is characterized in that the transponder is supplied with energy.

A refinement of the method, of the logistics system, of the container and of the computer program product according to an exemplary embodiment of the present invention provides for the energy to be supplied by the reading unit.

A refinement of the method, of the logistics system, of the container, of the transportation system and of the computer program product according to an exemplary embodiment of the present invention is characterized in that an interlayer absorbs electromagnetic radiation.

A refinement of the method, of the logistics system, of the container and of the computer program product according to an exemplary embodiment of the present invention provides for the interlayer to reflect electromagnetic radiation.

Numerous types of transponders are suitable for use according to an exemplary embodiment of the present invention. Especially preferred are exemplary transponders that serve as transmitting and/or receiving devices. In particular, these are receiving devices that, after receiving an external signal, are capable of transmitting a signal of their own.

As used herein, the term transponder is an abbreviation of transmitter and (signal) responder.

Special preference is given to the use of transponders that are provided with at least one identifier. Such transponders will be referred to below as RFID tags.

It is practical to replace or augment a visually detectable identification of objects in transportation or logistics systems with RFID technologies having electronically rewritable and readable transponders. Such systems entail the advantage that a great deal of information can be electronically written into and read out of a transponder, as a result of which automatic transportation, sorting, tracking or distribution procedures can all be regulated without a need for a visual display of information.

A transponder with identifiers (RFID tags) is preferably configured as an RFID tag. An RFID tag may include a microchip and an antenna. A code containing information that is relevant for the processing is stored on the chip. In particular, this information relates to information about an identification ID.

Transponders are configured in such a way that they themselves transmit and/or receive signals in response to a triggering (radio) signal from a reading device. Active transponders contain a source of energy for their operation. Passive transponders, in contrast, obtain energy from the signals transmitted by the reading device.

The technical implementation of the invention preferably comprises a database containing information about the mailpieces that are to be transported and about at least one device provided for accepting mailpieces.

It is especially advantageous for the database to contain information about several devices provided for dispatching objects and for accepting the mailpieces.

The transmission of selected, compressed and/or reduced values has the advantage that the storage and transfer capacities can be employed more efficiently.

Numerous types of reading devices are possible when transponders are used as the means for relaying the measured values.

Antennas tuned to the specific wavelengths of the electromagnetic radiation of the transponders are used.

It is particularly advantageous for the specific reading unit that is going to be employed to be equipped with the BRM function known from the state of the art.

The BRM function (Buffered Read Mode=data filtering and data storage) ensures that the data from transponders that have already been read out is placed into a buffer in the reader and is only read out once. This advantage plays a role in applications with bulk recognition (anti-collision), since it is always the case that only “new” transponders are read out. This increases the data transfer speed.

Information acquired in this manner is subsequently further processed.

Several types of transmission can be employed for the transmission to the reading unit.

The reading unit is arranged in a transportation system for the container, in a warehouse or in a processing center for the container.

A data processing unit that is preferably in communication with the reading device receives this mailing data from the reading unit.

A refinement of an exemplary embodiment of the present invention is characterized in that the position of the object is determined using a locating device that is in communication with the object, and the position of the object is associated with the received mailing data. In this context, the position of the object can be determined using a locating device directly on the object or on a transportation means with which the object is being transported. If the locating device is present on an appertaining transportation system, it is preferably in communication with the data processing unit of the object.

The position of the object can be determined, for instance, using a locating device in the form of a GSM module, a GPS module and/or a direction-finding transmitter. Here, the various types of locating device can be employed as a function of the degree of precision that is required of the position determination, whereby they can be used either perpendicularly or in parallel.

A refinement of the method, of the logistics system, of the object and of the computer program product according to an exemplary embodiment of the present invention provides for the mailing data obtained from the sensors to be compared to target values, whereby a deviation from a target value is considered as an alarm. The mailing data is preferably compared in that the measured electric properties of the conductive layers are compared to a target value of the electric properties. Here, it can be provided that a deviation of the physical properties of the object material detected by the sensors from a target value is not considered as an alarm if the deviation is associated with a position of the object that is stored in the data processing unit as a position in which it is permissible to open the object.

In an exemplary embodiment of the invention, the mailing data obtained from the sensor is transmitted to a communication module on the object and the communication module transmits the mailing data to a message-receiving device.

A refinement of an exemplary embodiment of the present invention provides for the use of at least one transponder as the communication module.

The mailing data can be transmitted from the communication module to the message-receiving device during the transportation route or after the object has arrived at the destination. Preferably, the mailing data is only transmitted during the transportation route if a comparison within the data processing unit has shown that there is deviation from the target values, particularly from the target times for the acceptance procedures.

An antenna, for instance, can be provided as the detection device. The mailpieces are registered in that the RFID tags located on the mailpieces are read out when the RFID tags move past the antenna during the dispatching procedure of the mailpieces.

The reading unit can also be provided with a bulk detector that detects the mailpieces when all of them have been placed into the container.

When the mailpieces are detected, at least the number of mailpieces placed into the containers is registered in the data processing unit. In this process, the number of mailpieces recorded in the data processing unit is reduced when an object is removed from the container, whereby the procedure of dispatching a mailpiece from the container is registered in that the number of procedures is detected by the unambiguously identifiable RFID tag that belongs to the object.

Via the connection to a central data processing unit, information about the objects can also be updated in the database, and the operation of the device can be adapted to changing requirements.

### BRIEF DESCRIPTION OF THE DRAWING

The FIGURE shows the following:

FIG. 1 is a diagram showing a surface of an information carrier according to an exemplary embodiment of the present invention.

### DETAILED DESCRIPTION OF SPECIFIC EMBODIMENTS

The surface of the information carrier contains mailing data, for instance, information about the invoice recipient, insurance, the mode of payment, the sender, the recipient, contact persons, about the mailpiece and about the contents of the mailpiece. Moreover, additional services can be selected in a field. Furthermore, the information carrier contains a mailpiece identifier (for example, 550 3433 552) in plain text as well as in the form of a barcode.

This surface of an information carrier according to an exemplary embodiment of the present invention corresponds to known mailing stickers and bills of lading which are likewise the basis of mailing stickers for the shipment of one or more objects that are to be mailed.

Information present on the information carrier can be been pre-printed and/or entered there manually. For instance, in the case of customers who send off multiple mailpieces, it is common practice to provide information carriers that already have a pre-printed sender address as well as, if applicable, a customer number.

Additional information, especially mailing information, can be applied onto the information carrier in handwritten form or by using a suitable printer, if necessary, in a separate processing procedure.

According to an exemplary embodiment of the present invention, the information carrier has the special feature that it additionally has a storage medium to store mailing data in electronic form.

In a particularly preferred exemplary embodiment, the storage medium is located between the layers of a multilayer information carrier. In an exemplary embodiment of the invention, the storage medium is provided by a transponder that has its own storage chip for storing the mailing data.

According to an exemplary embodiment of the present invention, the information carrier is provided with mailing data in a multi-step procedure:
1) labeling applied to the information carrier with readable mailing information in plain text,
2) optical detection of the mailing data in the form of optical information,
3) recognition of the mailing data contained in the optical information, and
4) transmission of the previously acquired mailing data to a storage medium.

Refinements provide for the expansion of the presented method steps and, if applicable, for their augmentation with additional method steps.

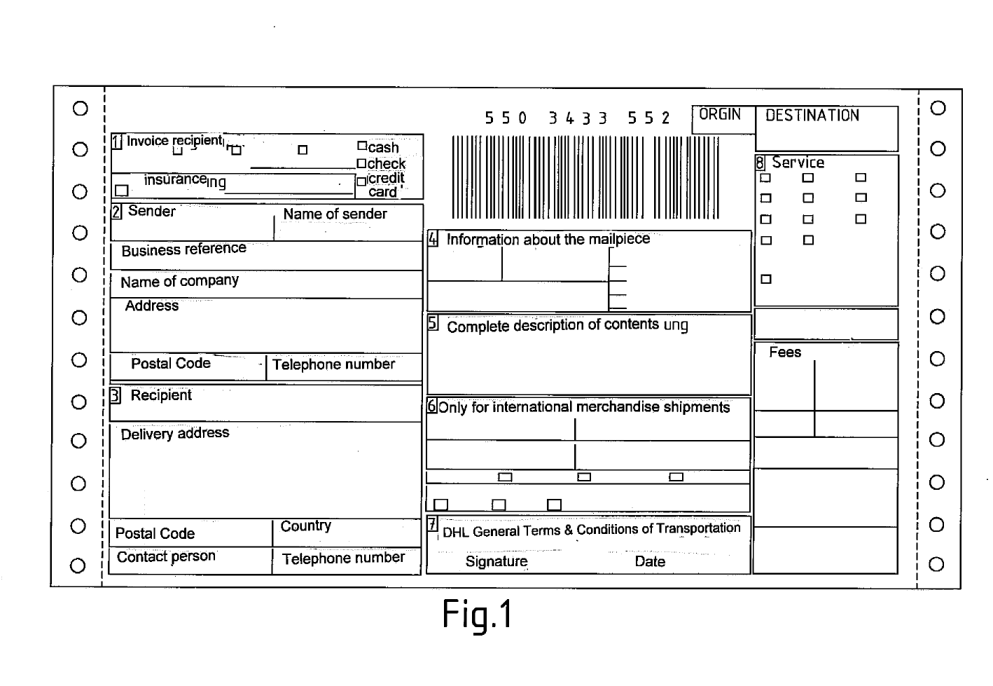

For example, method step 1 can be carried out in two partial steps, whereby a first partial step involves labeling the information carrier with printed information—especially in the form of a provided pre-print. The printed information is, in particular, information that can already be specified in advance of a transmission process. Here, this relates especially to provided mailpiece identifiers as well as designations of text fields. The designations for the text fields are marked with the reference numerals 1 to 8 in FIG. 1.

In another method step, mailpiece-specific mailing information is entered. In a practical manner, this is done in advance of a dispatching procedure, for example, by a customer as the user of the logistics system.

The mailing data is detected when the mailpieces are dispatched, especially when they are picked up by a person equipped with a mobile reading device.

Practical refinements of an exemplary embodiment of the present invention entail combining optical character recognition of mailing information present in plain text with the reading of machine-readable information—especially a barcode.

An exemplary embodiment of the invention provides for the dispatching procedure of the mailpiece to be configured in such a way that it comprises the presented detection steps for the mailing data.

It is particularly advantageous to carry out a writing procedure on the storage medium during the dispatching (acceptance) of the object that is to be mailed.

As a result, it is possible, for instance, that a bill of lading that has been previously prepared contains the basis for optically readable information in plain text as well as for digitally stored information contained in a storage medium.

In the manner described, it is ensured that the storage medium contains the mailing data and can thus influence the handling of the object that is to be transported in a logistics system.

1-13. (canceled)

14. A method for accepting an object that is to be transported, for purposes of being processed in a logistics system, the method comprising:
acquiring graphic information via optical image recognition;
evaluating the graphic information to ascertain mailing data about the object; and
transmitting and/or storing the mailing data.

15. The method recited in claim 14, comprising storing the mailing data on a storage medium.

16. The method recited in claim 15, wherein the storage medium works together with a transponder.

17. The method recited in claim 15, wherein the storage medium is connected to the object that is to be transported.

18. The method recited in claim 14, comprising:
dispatching the object into the logistics system; and
carrying out at least one processing step in the logistics system as a function of the mailing data.

19. The method recited in claim 14, comprising storing and/or transmitting the mailing data via an interaction with an interaction device associated with a container.

20. The method recited in claim 19, wherein the interaction device contains an information memory.

21. The method recited in claim 14, comprising storing and/or transmitting the mailing data via an interaction with a reading unit.

22. An information carrier that is connected to an object that is to be mailed, the information carrier comprising:
a surface that can be written with mailing information; and
a storage medium to store acquired graphic information.

23. The information carrier recited in claim 22, wherein the storage medium works together with a transponder.

24. The information carrier recited in claim 22, wherein the mailing information is ascertained at least partially by an evaluation of the acquired graphic information.

25. A mailpiece, comprising an information carrier connected to the mailpiece, the information carrier comprising a surface that can be written with mailing information, and a storage medium to store acquired graphic information.

26. A device that accepts objects that are to be transported, the device comprising:
a reading unit that is adapted to acquire graphic information that is present on a surface of an information carrier disposed on an object that is to be transported;
a computing device that is adapted to evaluate the graphic information; and
a transmitter that is adapted to transmit mailing information to a storage medium that can be connected to the information carrier.
